(19) United States
(12) Patent Application Publication
(10) Pub. No.: US 2014/0279182 A1
(43) Pub. Date: Sep. 18, 2014

(54) Digital Product Binder Library System and Method Thereof

(71) Applicants: Michael P. Goodman, Gilbert, AZ (US); Jeffery L. Carlson, Gilbert, AZ (US)

(72) Inventors: Michael P. Goodman, Gilbert, AZ (US); Jeffery L. Carlson, Gilbert, AZ (US)

(21) Appl. No.: 14/214,245

(22) Filed: Mar. 14, 2014

Related U.S. Application Data
(60) Provisional application No. 61/789,779, filed on Mar. 15, 2013.

(51) Int. Cl. G06Q 30/06

(52) U.S. Cl. CPC G06Q 30/0621; G06Q 30/0643
USPC 705/26.5

(57) ABSTRACT

A method of creating a library of custom digital product binders is presented. The method comprises the computer-implemented steps of creating a plurality of digital product binders to form a digital product library. Each digital product binder contains content corresponding to a physical product binder. The method further comprises receiving a selection of digital product binders from the digital product library, receiving branding information, creating a custom digital product library, associating each digital product binder with the custom digital product library, and adding the branding information to each digital product binder.

### CROSS REFERENCE TO RELATED APPLICATIONS

This application claims the benefit of U.S. Provisional Patent Application No. 61/789,779, filed Mar. 15, 2013, titled “Digital Product Binder Library System and Method Thereof” the entire contents of which are hereby incorporated by reference herein, for all purposes.

### TECHNICAL FIELD

The present invention relates to an interactive digital product library and, more particularly, to a system that enables the creation of an interactive digital product library from a plurality of physical product binders, and most particularly to a system that enables the creation of a digital product library containing digital product binders having portfolios and interactive layouts using content from the digital product library.

### BACKGROUND OF THE INVENTION

Physical product binders are used extensively in conjunction with the sale of many products. These binders generally contain the product selection for a particular manufacturer and include photos of the product and product details. The sales channels for these products, particularly office equipment, office furniture, and architectural products, involve the distribution of product binders to sales representatives. The sales representatives and design consultants generally use physical product binders from a number of different manufacturers when working with clients to, for example, select office furniture, equipment, and architectural components for a new office building.

Many manufactures make their product selection available on their website and some even make digital representations of their product binders available online. Sales representatives and consultants, however, continue to rely largely on the physical product binders for a number of reasons. First, design decisions generally require a side-by-side comparison of many different products. For example, when selecting the components of an office, the office chairs, desks, cubical walls, and file cabinets must be coordinated to achieve workable aesthetic and function qualities. It is often difficult to select a workable complement of office components by viewing each discrete component on a separate manufacturer's website. In comparison, physical product binders allow a sales representative or design consultant to create a spread of many different products to be viewed side-by-side. To facilitate these design activities, the pages in the product binders can generally be removed. In some cases, each page in the binder contains holes that are secured to the binder by a metal ring or other attachment mechanism that can be opened to selectively remove pages or closed to secure the pages back in the binder. In other cases, the binder is simply a folder for holding a series of product cut sheets. This allows sales representatives and design consultants to create and present an overall design to their client as well as the ability to work with their clients to make changes to the design.

Second, a building, office, or room design, for example, often comprises products from more than one manufacturer. Finding, bookmarking, and navigating each company's website or online product catalog, particularly, when each is configured in a different manner is cumbersome and distracting and makes the use of physical product binders, which are provided in a consistent and readily available format, more attractive.

Despite these benefits, physical product binders have a number of shortcomings. For example, they are large and bulky. As such, the number of binders that a sales representative or design consultant can bring to a client is limited, often requiring many clients to make in-person visits to the sales representative or design consultant in a design center. As cut-sheets (i.e., pages) are removed from a binder, they are often not replaced, resulting in incomplete binders. In addition, physical binders are very expensive, costing upwards of $200 per copy. This is a significant cost imposed on the manufacturer, who typically distributes many thousands of binders per product year. And finally, physical binders become outdated shortly after they are printed and are difficult and costly to update.

In addition, manufacturers generally have no visibility as to how often a given product is included in a design, until and unless the product is actually purchased. A manufacture will generally never know if a product was initially considered or include in a design and removed. And, a manufacture generally has no visibility as to what products from other companies are being included with their own product. This information would be greatly valuable to manufacturers in that it would provide them additional information to augment their product offerings, configurations, and prices.

While physical product binders with removable pages are useful during the design process, they typically only include a sample product photo. For example, a particular physical product binder may show the individual components for a modular desk and one example configuration, leaving it up to the imagination of the sales representative, design consultant or client to envision what a different configuration may look like and how it will aesthetically fit within a particular office layout and with other products, such as a particular file cabinet or chair.

Accordingly, it would be an advance in the state of the art to develop a system and method that can be used (i) to create a library of interactive digital product binders from a number of different manufactures, where each interactive digital product binder initially corresponds to a physical product binder, but provides interactive features and allows for product and price updates, (ii) by sales representatives and design consultants to create a custom interactive digital library for the manufacturers in which they are associated, (iii) to create an interactive custom digital portfolio comprising digital product pages from a number of interactive digital product binders, and (iv) to create an interactive design layout that includes products from a number of interactive digital product binders.

### SUMMARY OF THE INVENTION

A method of creating and presenting a library of custom digital product binders is presented. The method includes the computer-implemented steps of creating a plurality of digital product binders to form a digital product library. Each digital product binder comprises the contents of a corresponding physical product binder. The method further includes the computer-implemented steps of receiving a selection of digital product binders from the digital product library, receiving branding information, creating a custom digital product library, associating each digital product binder in the selection of digital product binders with the custom digital product library and adding the branding information to each digital product binder in the custom digital product library.

A method of creating and presenting a custom digital portfolio is also presented. The method includes the computer-implemented steps of identifying a product. The product is contained in a digital product binder. The method further includes the computer-implemented steps of adding a virtual product page corresponding to the product from the digital product binder to a custom project portfolio, adding the custom project portfolio to a digital product library. The custom project portfolio comprises product images from a plurality of digital product binders and, when displaying the digital product library, the custom product portfolio is displayed alongside other custom product portfolios and/or digital product binders.

A method of creating and presenting a custom design is also presented. The method includes the computer-implemented steps of creating a virtual layout page, accepting the selection of a product image from a virtual product page in a custom digital binder, accepting display configuration information for the product image. The display configuration information comprises placement of the product image within the virtual layout page, the size of the product image relative to the virtual layout page, the perspective of a three-dimensional representation of the product image, or a combination thereof. The method further includes the computer-implemented steps of adding the virtual layout page to a custom digital portfolio

### BRIEF DESCRIPTION OF THE DRAWINGS

The invention will be more fully understood by referring to the following Detailed Description of Specific Embodiments in conjunction with the Drawings, of which:

FIG. 1 is a flowchart of an exemplary computer-implemented method for creating a library of interactive digital product binders that each correspond to a physical product binder;

FIG. 2 is a flowchart of an exemplary computer-implemented method for creating a custom interactive digital product binder library;

FIG. 3 is a flowchart of an exemplary computer-implemented method for creating a custom digital portfolio from an interactive digital product library;

FIG. 4 is a flowchart of an exemplary computer-implemented method for creating a custom digital portfolio from physical products or physical product binders;

FIG. 5 is an exemplary screenshot of an interactive digital product library;

FIG. 6 is an exemplary screenshot of a custom interactive digital portfolio;

FIG. 7 is another exemplary screenshot of a custom interactive digital portfolio;

FIG. 8 is a diagram illustrating the use of augmented reality to interact with a product from the digital product library;

FIG. 9 is an exemplary screenshot of a user interface for creating an interactive design layout containing products from the digital product library;

FIG. 10 is a block diagram illustrating an exemplary embodiment of Applicants' system;

FIG. 11 is a block diagram illustrating the functional components of an exemplary embodiment of Applicants' system; and

FIG. 12 is an exemplary screenshot of a website containing an embedded digital library plugin.

### DETAILED DESCRIPTION OF PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

In certain embodiments, Applicants' system enables the creation of a customizable, interactive digital product binder library. In one embodiment, Applicants' system comprises a master digital product binder library, which in turn comprises a plurality of individual interactive digital product binders from a plurality of different manufacturers or distributors. In one embodiment, each digital product binder corresponds to a physical product binder from a single manufacturer or distributor.

In one embodiment, a digital product binder comprises a number of virtual pages. In some embodiments, a virtual page corresponds to a physical page or cut sheet in the corresponding physical binder and comprises text, images, tables, and diagrams. In some embodiments, the virtual pages include updatable fields, such as, for example, price information, product information, availability, additional product offerings, and companion products. In some embodiments, the virtual pages include interactive elements. In some embodiments, the interactive elements present a interactive three dimensional representation of the product. In other embodiments, the interactive elements allow a product image to be overlaid on a background image provided by the user. In yet other embodiments, the interactive elements allow the product image to be overlaid on a live video feed, so that the user can “virtually” place the product in an existing location to better visualize how the product would actually look in that location. In some embodiments, the interactive elements allow a product to be viewed with a variety of available styles or options, including for example without limitation, color, fabric options, accessories, and structural variations. In some embodiments, the digital product binders comprise virtual layouts having interactive elements that allow multiple virtual pages and/or multiple product images from one or more digital binders to be arranged in the same view.

In one embodiment, Applicants' system enables a user, such as a sales representative or a design consultant, to create a custom interactive digital library comprising a subset of digital binders from the master digital library. The subset is determined by the manufactures in which the user is associated. The user then uses the custom digital library when working with clients so that the binders available are only those in which the user is affiliated.

In one embodiment, Applicants' computer-implemented system enables a user, such as a sales representative, a design consultant, or client, to build an interactive custom portfolio. In certain embodiments, the custom portfolio includes virtual pages or virtual cut sheets from a plurality of digital binders from a variety of different manufactures and/or distributors. In certain embodiments, the custom portfolio includes product images and virtual layouts that contain multiple product images from multiple digital binders. The custom portfolio enables the user to effectively select a complement of products across multiple manufactures and/or distributors to create a complete design for, by way of example, an office area, commercial lobby, or a residential living area.

In one embodiment, the system is implemented on one or more application servers and one or more databases. In one embodiment, users interact with the system remotely using a web browser. In another embodiment, users interact with the system locally using an application running on the users computing or mobile device. The locally-running application may communicate with a centrally located remote database or with a local database running on the same system as the application. In one embodiment, the locally-running application and database receive updates from a centrally located database.

Referring to FIG. 1, a flowchart 100 of an exemplary computer-implemented method for creating a library of interactive digital product binders that each correspond to a physical product binder is depicted. The digital library may contain digital product binders that correspond to physical product binders, digital product binders that are created specifically for inclusion in the digital library (i.e., that do not correspond to physical binders), or a combination thereof. The phrase “correspond to a physical binder” means that the layout and content of the digital binder mimics that of the physical binder. However, the digital binder includes additional features and capabilities as will be further described below.

At step 102, the method receives a cover image of a physical product binder. The image is the entire outer portion of the binder. The image may be generated by taking a photo or digital scan of the front cover, back cover, and edge of the physical binder. Alternatively, the image may be generated from the original image or images used to produce the physical binder.

In one embodiment, the physical binder is from a single manufacturer or a single distributor. In one embodiment, the physical binder contains office furniture, office equipment, lighting products, architectural products, or a combination thereof.

At step 104, the method receives a page image for each physical page in the physical product binder. The images may be generated by taking a photo or digital scan of each page or cut sheet in the physical binder. Alternatively, the images may be generated from the original images used to produce the physical binder.

At step 106, the method creates a virtual page for each page image. In one embodiment, depending on the content of a page, the method receives information that distinguishes between individual products on the virtual page or associates multiple virtual pages with a single product.

At step 108, the method adds interactive fields to one or more virtual pages. Interactive fields enable a virtual page to retain the look and layout of the physical page from which it was derived, yet offer interactive capabilities to enhance user experience. In various embodiments, an interactive field comprises a three dimensional rotatable view of the product, a three-dimensional CAD file displayed in-place or launched in a new window containing a three-dimensional CAD viewer, a dynamic product view where aspects, such as without limitation colors, fabrics, dimensions, and features, can be selected and updated in the product view, other interactive elements, or a combination thereof. The dynamic product view allows many variations of the product to be viewed from multiple perspectives within a virtual page.

In one embodiment, the placement of the interactive fields within the virtual page and underlying data, such as three-dimensional models, are received by the method. In another embodiment, the placement of one or more interactive fields are automatically determined by the method and the method subsequently receives and associates the underlying data for each such field. Interactive fields may be automatically determined by analyzing the page image (received in step 104) during creation of the virtual page image (at step 106) and detecting embedded product images. The method then associates the embedded product image on the virtual page with an interactive element. During virtual page creation, the method allows a user to associate underlying data to an interactive element. In one embodiment, the data underlying an interactive field is stored in a central database and can be changed at any time. Such changes will appear on the relevant virtual page the next time the page is viewed.

At step 110, the method adds update fields to one or more virtual pages. Update fields enable a virtual page to retain the look and layout of the physical page from which it was derived, yet include dynamic elements capable of providing updated information. In various embodiments, an update field comprises product price, product availability, available product features, product options, other product information, or a combination thereof.

In one embodiment, the placement of the update fields within the virtual page and underlying data, and product pricing, are received by the method. In another embodiment, the placement of one or more update fields are automatically determined by the method and the method subsequently receives the underlying data for each such field. Update fields may be automatically determined by analyzing the page image (received in step 104) during creation of the virtual page image (at step 106) and detecting relevant information, such as price. The method then associates the information on the virtual page with an update field. During virtual page creation, the method allows a user to associate underlying data to an update element. In one embodiment, the data underlying an update field is stored in a central database and can be changed at any time. Such changes will appear on the relevant virtual page the next time the page is viewed.

At step 112, the method creates a digital product binder from the cover image and the virtual pages and stores the digital product binder in a database.

At step 114, the method adds the digital product binder to a digital product binder library by associating the digital product binder library with other digital product binders in the database. In one embodiment, the database contains a plurality of digital product binder libraries. In one embodiment, one digital product binder may be associated with multiple digital product binder libraries.

At step 116, the method displays a digital product binder library. Depending on the configuration of the system, displaying comprises sending data to a remote web browser or a remotely running application to render the display. Where the application is running locally, the method may render the display directly. The method ends at 118.

Referring to FIG. 2, a flowchart 200 of an exemplary computer-implemented method for creating a custom interactive digital product binder library is depicted. At step 202, the method displays a digital product binder library. The digital product binder library comprises a plurality of individual product binders from a plurality of different manufacturers and/or distributors. In one embodiment, multiple product binders are displayed simultaneously on a virtual bookshelf and are configured to appear the same as the physical product binder to which they relate would appear on an actual bookshelf. In one embodiment, the digital product binder library comprises digital product binders, which are a subset of the full digital product binder library, and that each share a common attribute. The attributes include, for example and without limitations, digital binders related to a particular group purchasing program, digital binders related to a single manufacturer or group of manufacturers, digital binders related to a particular category of products, digital binders related to a particular architectural style, digital binders related to a particular sales person, digital binders that are part of a particular proposal, a custom digital binder created by a user, or a combination thereof.

At step 204, the method receives a selection of digital product binders from the digital product binder library. In one embodiment, the selection is made when a user selects a digital product binder and drags the binder to a custom bookshelf. In one embodiment, the selection is made when a user clicks on a binder and chooses the option to add the binder to a custom bookshelf. The user can select one or more digital product binders to add to the custom library. In one embodiment, the selection of digital product binders contain binders from at least two different manufacturers (i.e., at least two different companies), thereby resulting in a custom digital product binder library comprising digital binders from a plurality of distinct manufactures.

At step 206, the method receives branding information from the user. In one embodiment, when the user is a sales representative or a design consultant, the branding information allows the custom library to be associated with the user. The branding information may include, for example without limitation, the user's word mark, logo, trademark, and/or other branding identifier, company name, and contact information. In one embodiment, the branding information associates the user with special pricing or special product offerings that are reflected in the update fields on the virtual pages in the digital product binders.

At step 208, the method creates a custom digital product binder library from the selection of digital product binders from step 204. The custom digital product binder library contains a subset of the full binder library.

At step 210, the method adds branding information to the custom digital product library and to the each digital product binder within the custom library. This allows the user to customize the digital product library such that the user, or the user's company, is associated with the customize library when the customize library is used by, or presented to, clients or potential clients.

At step 212, in the case of a web-based embodiment, the method provides a link to the custom digital product binder library. The link (i.e., universal resource locator or URL) is used by the user or the user's clients to access the custom digital product library from an Internet connected device. In one embodiment, a single user may create multiple custom digital product binders, each accessible via a unique URL. In one embodiment, no login is necessary to view the custom digital product binder library when viewed from the link. This allows the user to send the link to customers or potential customers, who can then view the custom digital product library without needing to create an account.

At step 214, the method collects usage statistics as users interact with the custom digital product binder library and binders within the library. The usage statistics comprise, in various embodiments and without limitation, the number of times a particular binder in the digital product binder library has been viewed by a user, the number of times a particular product in a particular binder in the digital product binder library has been viewed by a user, products across multiple binders that were viewed within a single usage session (as defined in one embodiment by IP address or login session) or within a short period of time by a user, products that have been added together to a portfolio or shopping cart, the geographic location in which the user is viewing the library, or the identity of the sales representative or design consultant to whom the custom library is associated.

At step 216, a report of the usage statistics is compiled from the usage statistics gathered in step 214. In various embodiments, the usage statistics are provided to the various manufacturers that have binders in the digital library to improve their product offerings or to provide product suggestions based on the current product being viewed by the user. The method end at 218.

Referring to FIG. 3, a flowchart 300 of an exemplary computer-implemented method for creating a custom digital portfolio from an interactive digital product library is depicted. At step 302, the method displays a digital product binder library. The digital product binder library comprises a plurality of individual product binders from a plurality of different manufacturers and/or distributors or a subset of digital product binders that share a common attribute. In one embodiment, multiple product binders are displayed simultaneously on a virtual bookshelf and are configured to appear the same as the physical product binder to which they relate would appear on an actual bookshelf.

The product binder library may be a custom digital product binder library, as described in FIG. 2 or the full library of digital product binders. Upon selection of a particular binder in the library, the user may browse the virtual pages contained within the binder. When viewing a desirable product, the user may add the product to a custom digital portfolio.

At step 304, the method receives a selection of a product within the binder. A custom digital portfolio is created at step 306 and the selected product is added to the custom digital portfolio in step 308. In one embodiment, the entire virtual page (or range of virtual pages, if more than one) related to the selected product is added to the custom digital portfolio. In one embodiment, the product image is added to the custom digital portfolio. The custom digital portfolio is stored in a database.

At step 310, the method adds the custom digital portfolio to the digital product binder library such that the portfolio appears on the virtual bookshelf as part of the product binder library.

At step 312, in the case of a web-based embodiment, the method provides a link to the custom digital portfolio. The link (i.e., universal resource locator or URL) is used by the user or the user's clients to access the custom digital portfolio from an Internet connected device.

At step 314, the method accepts layout information relating to multiple products in the custom digital portfolio. In one embodiment, layout information comprises a selection of products, and the arrangement of those products relative to each other on an interactive page. In one embodiment, the method receives a selection of products from the user to arrange in a layout by selecting the product images or interactive fields on the virtual pages in the custom digital portfolio or digital product binder. The user, through a drag-and-drop or click operation, adds the products to a layout page. The user then arranges the products relative to each other to achieve the desired arrangement on the layout page.

At step 316, the method creates a layout page based on the layout information. At step 318, the method adds the layout page to the custom digital portfolio. The method ends at step 320.

Referring to FIG. 4, a flowchart 400 of an exemplary computer-implemented method for creating a custom digital portfolio from physical products or physical product binders is depicted. At step 402, the method creates a custom digital portfolio and adds the portfolio to a database.

At step 404, the method receives identification information related to a product. In one embodiment, each product within the physical binder is marked with a Quick Response Code (QR Code) or bar code that can be used to identify the product. The user captures the QR Code or bar code using a camera connected to a computing device or mobile device and provides the information to the method. This enables the method to identify the product based on the QR Code or bar code. In another embodiment, each product is equipped with an RFID or other near-field communication device that allows the product to be identified wirelessly, and without relying on a visual coding scheme, using mobile devices equipped with compatible technology.

At step 406, the method uses the identification information to determine the digital product binder that contains the product and the specific virtual page (or virtual pages) within the binder that contain the product information. The identified virtual page(s) are presented to the user.

At step 408, upon confirmation from the user, the method adds the virtual page (or virtual pages) that contains the product information to the custom digital portfolio. In one embodiment, the product image (as opposed to the entire virtual page) is added to the custom digital portfolio.

At step 410, the method adds the custom digital portfolio to the digital product binder library such that the portfolio appears on the virtual bookshelf as part of the product binder library.

At step 412, in the case of a web-based embodiment, the method provides a link to the custom digital portfolio. The link (i e, universal resource locator or URL) is used by the user or the user's clients to access the custom digital portfolio from an Internet connected device.

At step 414, the method accepts layout information relating to multiple products in the custom digital portfolio. In one embodiment, layout information comprises a selection of products, and the arrangement of those products relative to each other on an interactive page. In one embodiment, the method receives a selection of products from the user to arrange in a layout by selecting the product images or interactive fields on the virtual pages in the custom digital portfolio or digital product binder. The user, through a drag-and-drop or click operation, adds the products to a layout page. The user then arranges the products relative to each other to achieve the desired arrangement on a layout page.

At step 416, the method creates a layout page based on the layout information. At step 418, the method adds the layout page to the custom digital portfolio. The method ends at step 420.

Referring to FIG. 5, an exemplary screenshot of a user interface 500 for an interactive digital product library is depicted. In the embodiment depicted, the screenshot is from a web browser. The web browser renders the display based on data sent to it from a remote server. In another embodiment, the display is rendered within an application running locally on the user's computing or mobile device.

In one embodiment, the user interface 500 contains a browser bar 502 comprising an address bar 506 and navigation controls 504. Depending on the user's web browser, the browser bar may contain other buttons and controls.

An upper toolbar 508 is disposed under the browser bar 502. In one embodiment, user account tools 510 are included in the upper toolbar 508. The user account tools 510 allow the user to access their account information and log out of a login session.

In one embodiment, library navigation tools 516 are included in the upper toolbar 508. The library navigation tools 516 allow the user to view the main library or to view a subset of items in the library based on predefined criteria, such as for example, new products, new binders, or binder categories.

In one embodiment, a search box 512 is included in the upper toolbar 508. The search box 512 allows the user to limit the digital product binders 514 displayed in the virtual bookshelf 518. For example, entering the search term “office desk” in the search box 512 will limit the binders 514 displayed on the virtual bookshelf 518 to only those that contain products containing the term “office desk”. Similarly, entering the search term “Acme Office Equipment” in the search box 512 will limit the binders 514 displayed on the virtual bookshelf 518 to only those that contain office equipment from Acme.

The user interface 500 contains a virtual product binder bookshelf 518, which contains digital product binders 514. In one embodiment, the bookshelf 518 displays the entire digital product binders library. In one embodiment, the bookshelf 518 displays a custom library (as described in FIG. 2). In one embodiment, each digital product binder 514 is created as described in FIG. 1. In one embodiment, the virtual product binder bookshelf 518 contains user-created custom portfolios 530 as described in FIG. 3. The visible portion of each digital product binder 514 on the bookshelf corresponds to the edge portion (i.e., binder portion) of the physical binder in which the digital product binder relates. As such, a user can easily view the content of the library.

A lower toolbar 520 is disposed under the virtual product binder bookshelf 518. In one embodiment, a help tool 522 is included in the lower toolbar 520. The help tool 522 provides the user access to documentation and other content on how to use and interact with the digital product binders and libraries. In one embodiment, a Contact Us tool 524 is included in the lower toolbar 520. The Contact Us tool 524 provides the user with contact information for the web site administrators.

In one embodiment, an advertisement panel 526 is disposed below the lower toolbar 520. In one embodiment, a second advertisement panel 528 is disposed below the lower toolbar 520. In one embodiment, the advertisement panels 526 and 528 contain targeted advertisements based on the product the user is currently viewing or has viewed in the past. In one embodiment where the virtual bookshelf 518 contains a custom library with branding information (as described in FIG. 2), one of the advertisement panels 526 or 528 contains the branding information provided by the user who created the custom library.

In one embodiment, the advertisement panels 526 and/or 528 contain a product contained in one of the digital binders 514 on the virtual bookshelf 518. When a user clicks on such a advertisement, the binder containing the product is opened to the virtual page in the binder where the product is contained. In one embodiment, the product displayed in advertisement panels 526 and/or 528 are selected based on the viewing history of the user.

Referring to FIG. 6, an exemplary screenshot of a user interface 600 of a custom interactive digital portfolio is depicted. In the embodiment depicted, the screenshot is from a web browser. The web browser renders the display based on data sent to it from a remote server. In another embodiment, the display is rendered within an application running locally on the user's computing or mobile device.

In one embodiment, the user interface 600 contains a browser bar 602 comprising an address bar 638 and navigation controls 604. Depending on the user's web browser, the browser bar may contain other buttons and controls.

An upper toolbar 606 is disposed under the browser bar 602. In one embodiment, user account tools 610 are included in the upper toolbar 606. The user account tools 610 allow the user to access their account information and log out of a login session.

In one embodiment, a navigation button 608 is included in the upper toolbar 606. The navigation button 608 allows the user to return to the binder library (as depicted in FIG. 5).

In one embodiment, a search box 632 is included in the upper toolbar 606. The search box 632 allows the user to search within the current digital product binder and limit the products displayed to those that match the user's search criteria. For example, entering the search term “office desk” in the search box 632 will limit the products 614 displayed in the binder page 636 to only those products that match the term “office desk”. Similarly, entering the search term “Acme Office Equipment” in the search box 632 will limit the products 614 displayed on the virtual page 636 to only office equipment from Acme.

Two virtual pages 634 and 636 are disposed below the upper toolbar 606. In one embodiment, the left virtual page 634 includes a panel 620. In one embodiment, the panel 620 contains an advertisement. In one embodiment, the advertisement may be based on content of the opposing virtual page 636 or on the user's previous use of the binder or library.

In one embodiment, the left virtual page includes a second panel 622. In one embodiment where the current binder is in a custom library having branding information (as described in FIG. 2), the second panel 622 contains the branding information provided by the user who created the custom library. In another embodiment, the panel 622 includes an additional advertisement. In one embodiment, the panel 620 includes the branding information.

In one embodiment, virtual page 636 contains a listing of product photos 614. In one embodiment, tabs 612 are disposed alongside the page 636. The tabs allow the user to choose the particular products displayed on the page 636. For example, the tabs 612 may list product categories, such as chairs, desks, file cabinets, etc. . . . When a user selects one of the particular tabs 612, the products 614 displayed on page 636 will match the criteria for the selected tab.

A lower toolbar 628 is displayed below pages 634 and 636. In one embodiment, a help tool 630 is included in the lower toolbar 628. The help tool 630 provides the user access to documentation and other content on how to use and interact with the digital product binders and libraries. In one embodiment, a Contact Us tool 640 is included in the lower toolbar 628. The Contact Us tool 628 provides the user with contact information for the web site administrators.

In one embodiment, an advertisement panel 624 is disposed below the lower toolbar 628. In one embodiment, a second advertisement panel 626 is disposed below the lower toolbar 628. In one embodiment, the advertisement panels 624 and 626 contain targeted advertisements based on the product the user is currently viewing or has viewed in the past.

In one embodiment, advertisement panel 624 and/or 626 contain a product contained in one of the digital binders in the current library. When a user clicks on such as advertisement, the binder containing the product is opened to the virtual page in the binder where the product is contained.

Referring to FIG. 7, another exemplary screenshot of a user interface 700 of an custom interactive digital portfolio is depicted. In one embodiment, virtual page 708 comprises a product image 702 and additional product information 704 and 706. The additional product information may include, without limitation, a description of the product, product dimensions, or product options. In one embodiment, the virtual page 708 has the identical layout and content as the physical product binder from which it was derived, except that the virtual page 708 additionally contains interactive and/or update fields.

In some embodiments, the product image 702 includes an interactive field, which allows the user to interact with the product image. In one embodiment, the interactive field is a three dimensional interactive view of the product that allows the user to rotate and view the product from multiple perspectives. In one embodiment, the interactive field allows the user to select the colors, designs, and/or fabrics on the product image, interact with a three-dimensional representations of the product, change other options displayed in the product image, or a combination thereof.

In one embodiment, the design and/or fabric samples made available by the manufacturer for a product are displayed on the user interface 700 and, upon selection of a particular design or fabric by the user, the design or fabric is mapped to a two-dimensional or three-dimensional representation of the product to create product image 702.

In one embodiment, product information 706 includes an update field 710. The update field 710 is, in different embodiments, the product price, product options, product availability, or a combination thereof. In some embodiments, the update field 710 provides product specials and advisories, such as a sale or upcoming price increase, or a special price for the logged in user. In some embodiments, product information 704 and 706 each contain one or more update fields 710. The contents of the update fields can be updated at any time without the need to replace the entire virtual page 708.

Referring to FIG. 8, a diagram 800 illustrating the exemplary use of augmented reality to interact with a product 810 from the digital product library is depicted. The camera on a mobile device 806, such as a smart phone, a tablet, or other Internet connected device equipped with a camera, is directed toward a scene comprising a file cabinet 802 and table 804 by a user who wishes to evaluate the addition of a stool to the scene. The scene may be an actual location in a room or office or may be a page in a catalog or magazine. The broken lines 808 depict the field of view of the camera on the mobile device 806.

A live image of the scene is streamed to the screen 812 on the mobile device 806. As the field of view 808 of the camera moves over the scene, the view on the screen 812 is instantly updated to reflect the current image captured by the camera.

A image of a product 810 selected from a digital product binder in a digital product library configured for a mobile device is superimposed over the scene on the screen 812. In one embodiment, the placement and size of the product image 810 on the screen 812 can be adjusted by touching and dragging the product image 810 on the screen 812 or using a pinch gesture to shrink or enlarge the image to achieve the proper proportions and placement that is appropriate to the scene captured by the camera.

In one embodiment, the product image 810 is sent from a digital product library on a desktop or tablet computing device to the mobile device 806 via an email, instant messaging, or via an app running on the mobile device 806 that can be directly addressed by the digital product library.

Referring to FIG. 9, an exemplary screenshot of a user interface for creating an interactive design layout containing products from the digital product library is depicted. Product image 904-910 from products 614 selected from a virtual page 636 (on FIG. 6) or products 702 selected from a virtual page 708 (on FIG. 7) are added to a layout page 902. In one embodiment, product images from any digital product binder in the virtual library may be added to the layout page 902.

In one embodiment, a background image of a space or environment is inserted behind the product images 904-910, thereby allowing the products to be viewed in the space or environment for which they are intended to be placed.

In one embodiment, the product images 904-910 are static images. In one embodiment, the product images 904-910 are interactive fields that allow the user to manipulate the view of the product, such as manipulating a three-dimensional representation of the object, or the product color, dimensions, or other product options.

Product images 904-910 may be moved and arranged in different positions relative to each other on the layout page 902, thereby allowing the user to create a number of design scenarios using the complement of selected products 904-910.

In one embodiment, the user can navigate to the virtual page within the custom portfolio or the virtual page within the original digital binder that contains the product by selecting the image 904-910.

In one embodiment, the system provides a URL to the custom product portfolio. In one embodiment, the layout page 902 can be viewed alone (i.e., not displayed alongside other virtual product pages). In one embodiment, the system provides a URL to the layout page 902, which enables users (and the user's clients) to view the layout page alone (i.e., without any other virtual pages).

In some embodiments, each digital product library, each digital product binder, and each virtual page may be associated with, and independently addressable by, a unique URL. As such, users and clients may directly and singly view one of these items in their web browser.

Referring to FIG. 10, a block diagram 1000 illustrating one embodiment of Applicants' system is depicted. A storage device 1002 holds data to be used by the system. The storage device 1002 may comprise a hard drive or RAID array. The storage device 1002 may be a single virtual system spread over a plurality of physical devices.

The components of Applicants' system may be embodied in a process component 1004. In one embodiment, the process component 1004 includes a database 1006, application binaries 1008, and an operating system 1010. In various embodiments, the application binaries 1008 include a digital product binder engine, a digital product library engine, an interactive and update field engine, and a usage statistic engine.

In one embodiment, the database 1006 comprises user accounts 1012, digital product binders 1014, product binder libraries 1016, custom digital portfolios 1018, and content for interactive and update fields 1020.

In one embodiment, the application binaries 1008 include a mail server 1022, a web server 1024, a database engine 1026, and a three-dimensional rendering engine 1028.

In one embodiment, the different components 1012-1028 are spread across multiple physical storage devices. In one embodiment, the components 1012-1028 are hosted in a shared data storage or elastic cloud computing environment where the components 1012-1028 share physical hardware with other applications and where the presence of one or more components are allocated and deallocated across multiple physical systems as needed.

The storage device 1002 is in communication with a computer device 1030 through a storage interface 1032. The storage interface 1032 is part of the interface bus 1034. The interface bus 1034 also comprises an I/O interface 1036 and a network interface 1038.

A system bus 1040 is in communication with the interface bus 1034, a processor (i.e., a central processing unit or “CPU”) 1042, random access memory (RAM) 1044, read-only memory (ROM) 1046, and a clock 1048.

A computing device 1052 is in communication with the network interface 1038 through a communications network 1050. In various embodiments, the computing device 1052 is a desktop PC, a laptop, a tablet PC, a tablet device, a smart phone or other mobile device, or any other Internet abled device. In various embodiments, the communication network is the Internet, a local area network (LAN), a cellular network, a wireless network, or a combination thereof. A user 1054 interacts with the system through the computing device 1052.

In some embodiments, the computing device 1030 is on a dedicated piece of hardware. In other embodiments, the computing device 1030 is within a shared computing or elastic cloud computing environment where the resources are allocated and deallocated as necessary across one or more of a number of individual pieces of hardware. In one embodiment, the computing device 1030 is the user's computing device, such as a personal computer, laptop computer, mobile device, or tablet device.

Referring to FIG. 11, a block diagram 1100 illustrating the functional components of an exemplary embodiment of Applicants' system is depicted. An application server 1102 comprises a digital binder engine 1104, a usage statistic engine 1106, an interactive field engine 1108, an update field engine 1110, and a mobile application programming interface (API) 1112.

The digital binder engine 1104 handles the interaction with and storage, presentation, organization, and content of each digital product binder. The usage statistic engine 1106 handles the collection of user interactions with each product, binder, and library and compiles reports based on such interactions. The interactive field engine 1108 handles the content of, and the user interaction with, the interactive fields on the virtual pages of each digital product binder. The update field engine 1110 handles the content of the update fields on the virtual pages of each digital product binder. The mobile API 1112 enables the features of the system, such as those depicted in FIG. 8, to be made available via a mobile application 1114 running on a tablet, smart phone, or other Internet-connected mobile device.

The database 1124 stores data necessary for operation of the system, including digital product binders 1126, product binder libraries 1128, custom digital portfolios 1130, user accounts 1132, and interactive and update field data 1134.

A user interacts with the system through one or more user interfaces (UIs) 1116. The different user interfaces 1116 comprise a digital product binder library UI 1118, a digital binder UI 1120, and a custom digital product binder library UI 1122.

In one embodiment, at least one of the user interfaces 1116 is a web interface (i.e., the user interacts with the UI through a web browser). In one embodiment, at least one of the user interfaces 1116 is a mobile application (i.e., the user interacts with the UI by launching an application on a mobile device, such as a smart phone or a tablet device). In one embodiment, at least one of the user interfaces 1116 is a application running on a personal computer (i.e., the user interacts with the UI by launching an application on a personal computer, such as a laptop or desktop).

The digital product binder library UI 1118 enables the user to browse the digital binder product library. The digital binder UI 1120 enables the user to view and interact with an individual digital product binder. The custom digital product binder library UI 1122 enables the user to browser a custom digital binder product library that contains branding information.

Referring to FIG. 12, an exemplary screenshot 1200 of a website containing an embedded digital library plugin is depicted. The website comprises content 1202. In some embodiments, the website is a manufacturer's website, a sales representative's website, or another 3rd party website having the manufacturer's, sales representative's, or 3rd party's content 1202, respectively.

The website also comprises a digital product library plugin 1204. In various embodiments, the digital product library plugin 1204 displays the full digital product library, or a custom digital product library. In one embodiment, the digital product library plugin 1204 includes at least one custom digital portfolio.

In one embodiment, upon selecting a particular digital product binder in the digital product library plugin 1204, the actual digital product binder or the custom digital portfolio is displayed, as shown in FIG. 6. In one embodiment, when the digital product library plugin 1204 is selected, a full view of the library depicted in the digital product library plugin 1204, i.e. the full library or a custom library, is displayed, as shown in FIG. 5. In one embodiment, no login is necessary to view the digital binders displayed within the plugin 1204.

As would be appreciated by those of skill in the art, although some embodiments, examples, and/or figures herein pertain to digital product binders for furniture, office equipment, and architecture components, the methods and systems described herein could be applied to product binders for any other type of products.

A digital product binder system has been described as including a processor controlled by instructions stored in a memory. The memory may be random access memory (RAM), read-only memory (ROM), flash memory or any other memory, or combination thereof, suitable for storing control software or other instructions and data. Some of the functions performed by the digital product binder system have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. For example, although some aspects of a digital product binder system have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as being limited to the disclosed embodiment(s).

What is claimed is:

1. A method of creating a library of custom digital product binders, comprising the computer-implemented steps of:
creating a plurality of digital product binders to form a digital product library;
wherein each digital product binder in said plurality of digital product binders contains content corresponding to a physical product binder;
receiving a selection of digital product binders from said digital product library;
receiving branding information;
creating a custom digital product library;
associating each digital product binder in said selection of digital product binders with said custom digital product library; and
adding said branding information to each digital product binder in said selection of digital product binders.

2. The method of claim 1, further comprising the computer-implemented steps of:
displaying said custom digital product library on an electronic display;
receiving a request to display a first digital product binder from said custom digital product library; and
displaying said first digital product binder with said branding information on said electronic display.

3. The method of claim 2, further comprising the computer-implemented steps of:
adding an update field to a virtual page in said first digital product binder;
receiving information related to said update field;
associating said information with said update field; and
upon displaying said virtual page within said first digital product binder, displaying said information in said update field.

4. The method of claim 2, further comprising the computer-implemented steps of:
adding an interactive field to a virtual page in said first digital product binder;
receiving information related to said interactive field;
associating said information with said interactive field; and
upon displaying said virtual page within said first digital product binder, displaying said information in said interactive field.

5. The method of claim 2, further comprising the computer-implemented steps of creating a unique URL to said custom digital product library, wherein said custom digital product library is displayed when said unique URL is entered into a web browser.

6. A method of creating a custom digital portfolio, comprising the computer-implemented steps of:
receiving a first product selection from a first digital product binder;
creating a custom project portfolio;
adding a first virtual product page corresponding to said first product selection to said custom project portfolio;
receiving a second product selection from a second digital product binder;
adding a second virtual product page corresponding to said second product selection to said custom project portfolio; and
adding said custom project portfolio to a custom digital product library, wherein:
when displaying said custom digital product library, said custom product portfolio is displayed alongside other custom product portfolios and/or digital product binders.

7. The method of claim 6, further comprising the computer-implemented steps of:
adding an update field to said first virtual product page;
receiving information related to said update field;
associating said information with said update field; and
upon viewing said first virtual product page, displaying said information in said update field.

8. The method of claim 6, further comprising the computer-implemented steps of:
adding an interactive field to said first virtual product page;
receiving information related to said interactive field;
associating said information with said interactive field; and
upon viewing said first virtual product page, displaying said information in said interactive field.

9. The method of claim 6, further comprising the computer-implemented steps of creating a unique URL to said custom digital product library, whereas said custom digital product library is displayed when said unique URL is entered into a web browser.

10. The method of claim 6, wherein said receiving a first product selection comprises displaying said first digital product binder and accepting a product selection from said first digital product binder.

11. The method of claim 6, wherein said receiving a first product selection comprises scanning a QR code or a bar code with an Internet connected device, and further comprising the computer implemented steps of displaying, on an electronic display, a virtual page associated with said QR code or said bar code.

12. The method of claim 6, further comprising the computer-implemented steps of:
creating a virtual layout page;
receiving a first image selection related to said first product selection to determine a first image;
receiving a second image selection related to said second product selection to determine a second image;
accepting display configuration information for said first image and said second image, wherein said display configuration information comprises placement of said first image and said second image within said virtual layout page, size of said first image and said second image relative to said virtual layout page, a perspective representation or a three-dimensional representation of said first image and said second image, or a combination thereof; and
adding said virtual layout page to said custom digital portfolio.

13. The method of claim 12, further comprising the computer-implemented steps of:
accepting a background image; and
applying said background image to said virtual layout page.

14. A method of creating a custom design layout, comprising the computer-implemented steps of:
creating a virtual layout page;
accepting a product image selection from a virtual product page in a custom digital binder to determine a product image;
accepting display configuration information for said product image, wherein said display configuration information comprises placement of said product image within said virtual layout page, size of said product image relative to said virtual layout page, a perspective representation or a three-dimensional representation of said product image, or a combination thereof; and
adding said virtual layout page to a custom digital portfolio.

15. The method of claim 14, further comprising the computer-implemented steps of:
accepting a background image; and
applying said background image to said virtual layout page.
